(19) United States
(12) Patent Application Publication
(10) Pub. No.: US 2025/0305359 A1
(43) Pub. Date: Oct. 2, 2025

(54) LADDAR RAIL LOCK

(71) Applicant: Tricam Industries, Inc., Eden Prairie, MN (US)

(72) Inventors: Benjamin M. Wernberg, Savage, MN (US); Joseph P. Foley, Mendota Heights, MN (US); Benjamin P. Williams, Chaska, MN (US)

(73) Assignee: Tricam Industries, Inc., Eden Prairie, MN (US)

(21) Appl. No.: 18/621,375

(22) Filed: Mar. 29, 2024

(51) Int. Cl. E06C 7/06; E06C 1/12

(52) U.S. Cl. CPC E06C 7/06; E06C 1/12

(57) ABSTRACT

A ladder rail lock for extendable ladders having slidable rails that includes a body, a handle, and a plug in which the handle can move from a locked position in a crevice of the body to an unlocked position in a notch with a rampart between the crevice and the notch to facilitate transition between locked and unlocked positions.

### FIELD OF THE INVENTION

The present disclosure relates generally to multi-position ladders and extension ladders, and more particularly to a twisting ladder rail lock that simplifies locking/unlocking of sliding rails with a more compact profile.

### BACKGROUND OF THE INVENTION

For some time, it has been known that constructing ladders with two sections that are slidably mounted with respect to each other enables the overall length of the extension ladder to be varied depending upon the desired use of the extension ladder. This feature is particularly useful for transporting the ladder to a desired use location.

Portable ladders are commonly used for a variety of applications, with several different styles being widely used. Two types of ladders utilize sliding rails to allow extension of rail length: extension ladders and multi-position ladders. To allow the rails of these types of ladders to extend (and shorten), a locking mechanism is necessary to prevent one or more rails from inadvertently moving while in use.

### SUMMARY OF THE INVENTION

Embodiments of the present disclosure provide an improved locking mechanism for ladders with slidably coupled rails. In one embodiment a ladder rail lock has a handle with a bottom contour that mates within a crevice of a base in a locked position. The ladder rail lock includes a biasing member, such as a spring, to bias the handle in the locked position. The ladder rail lock is rotatable about a central axis shared with a plug that engages openings in the slidably coupled rails when in the locked position. The handle can be rotated to a second position that disengages the plug from the opening in the slidably couple rails to unlock the ladder. To maintain the lock in the unlocked position, the base has notches to hold the handle bottom contour and prevent the handle's rotation. The notches are at a distance from the base bottom that maintains plug in a disengaged position with relation to the openings in the slidably coupled rails. A further embodiment of the handle has wings that extend beyond the footprint of the base in both the locked and unlocked positions.

Another embodiment includes the base of the ladder rail lock being dimensioned to provide a minimal sizing that will provide the necessary strength and durability while minimizing the probability of the lock catching on something while being moved or from individuals from catching clothing or tools on the ladder when moving near the ladder. A further embodiment of the base includes bolt head slots and bolt shaft orifices that facilitate the replacement or repair of the lock. Preferably the base has a substantially square footprint and includes lips that are formed to fit the profile of the ladder rail to which it is mounted.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

FIG. 1 is a perspective front right view of a ladder rail lock in the locked position according to an embodiment of the present invention.

FIG. 2 is a front elevation view of the ladder rail lock of FIG. 1.

FIG. 3 is a rear elevation view of the ladder rail lock of FIG. 1.

FIG. 4 is a right side elevation view of the ladder rail lock of FIG. 1.

FIG. 5 is a left side elevation view of the ladder rail lock of FIG. 1.

FIG. 6 is a top plan view of the ladder rail lock of FIG. 1.

FIG. 7 is a bottom plan view of the ladder rail lock of FIG. 1.

FIG. 8 is a is a perspective left front view of the base of the ladder rail lock of FIG. 1.

FIG. 9 is a front elevation view of the base of the ladder rail lock of FIG. 1.

FIG. 10 is a rear elevation view of the base of the ladder rail lock of FIG. 1.

FIG. 11 is a right side elevation view of the base of the ladder rail lock of FIG. 1.

FIG. 12 is a left side elevation view of the base of the ladder rail lock of FIG. 1.

FIG. 13 is a top plan view of the base of the ladder rail lock of FIG. 1.

FIG. 14 is a bottom plan view of the base of the ladder rail lock of FIG. 1.

FIG. 15 is a is a perspective front right view of the handle of the ladder rail lock of FIG. 1.

FIG. 15A is a perspective bottom right view of the handle of the ladder rail lock of FIG. 1.

FIG. 16 is a front elevation view of the handle of the ladder rail lock of FIG. 1.

FIG. 17 is a rear elevation view of the handle of the ladder rail lock of FIG. 1.

FIG. 18 is a right side elevation view of the handle of the ladder rail lock of FIG. 1.

FIG. 19 is a left side elevation view of the handle of the ladder rail lock of FIG. 1.

FIG. 20 is a top plan view of the handle of the ladder rail lock of FIG. 1.

FIG. 21 is a bottom plan view of the handle of the ladder rail lock of FIG. 1.

FIG. 22 is a cross-sectional view taken along the line A-A in FIG. 20.

FIG. 23 is a partial sectional right side elevation view of the handle of the ladder rail lock of FIG. 1.

FIG. 24 is a right side elevation view of the plug of the ladder rail lock of FIG. 1.

FIG. 25 is a perspective bottom front view of the plug of the ladder rail lock of FIG. 1.

FIG. 26 is a right side elevation view of portion of a ladder with the ladder rail lock of FIG. 1 in the locked position.

FIG. 27 is a front elevation view of a portion of a ladder with the ladder rail lock of FIG. 1 in the locked position.

FIG. 28 is a top plan view of a portion of a ladder with the ladder rail lock of FIG. 1 in the locked position.

FIG. 29 is a right side elevation view of portion of a ladder with the ladder rail lock of FIG. 1 in the unlocked position.

FIG. 30 is a front elevation view of a portion of a ladder with the ladder rail lock of FIG. 1 in the unlocked position.

FIG. 31 is a top plan view of a portion of a ladder with the ladder rail lock of FIG. 1 in the unlocked position.

While the various embodiments of the invention are amenable to various modifications and alternative forms, specifics thereof have been shown by way of example in the drawings and will be described in detail. It should be understood, however, that the intention is not to limit the invention to the embodiments described. On the contrary, the intention is to cover all modifications, equivalents, and alternatives falling within the spirit and scope of the inventions as may be claimed.

### DETAILED DESCRIPTION OF THE PREFERRED EMBODIMENTS

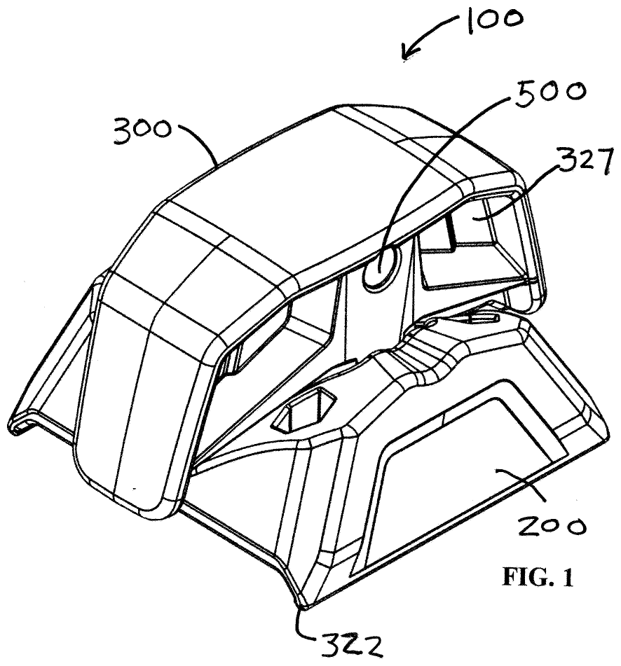

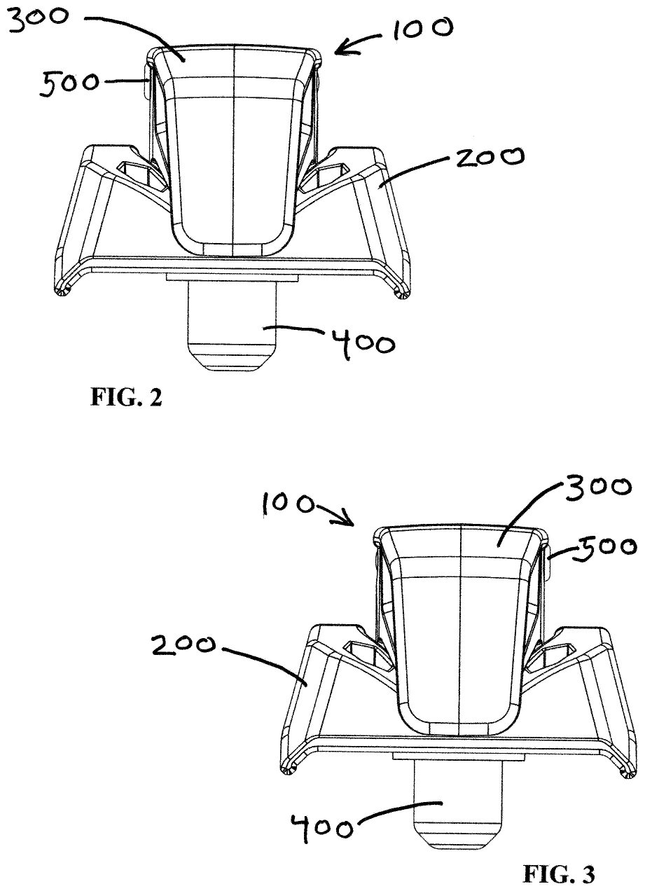

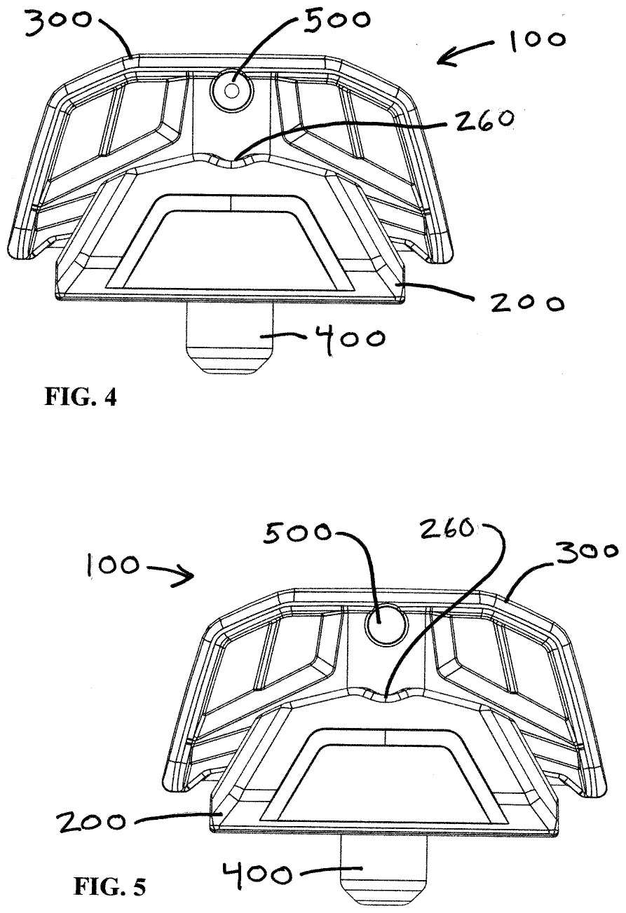

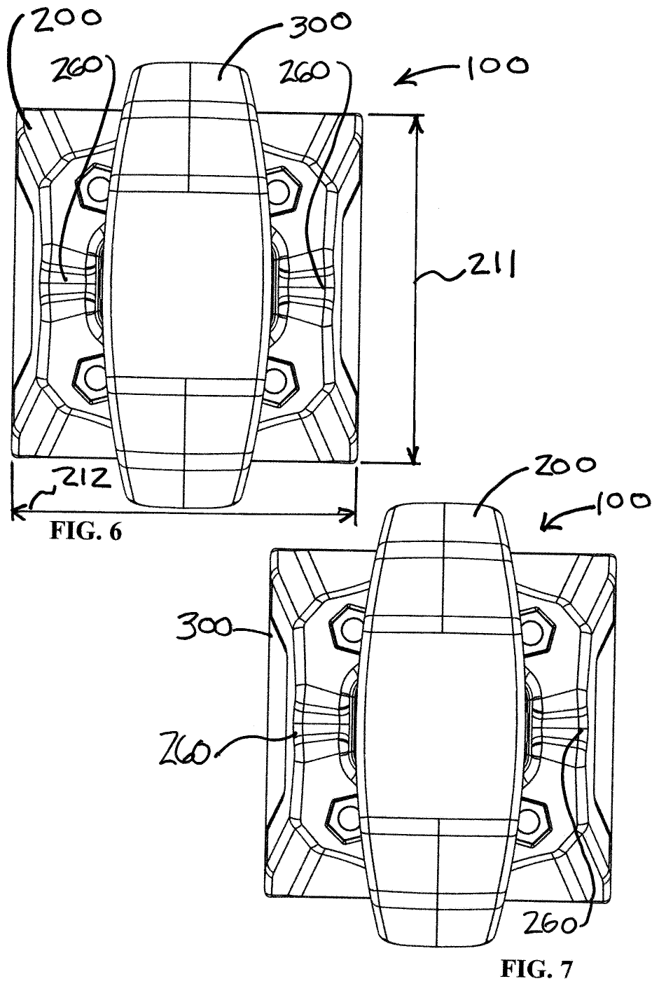

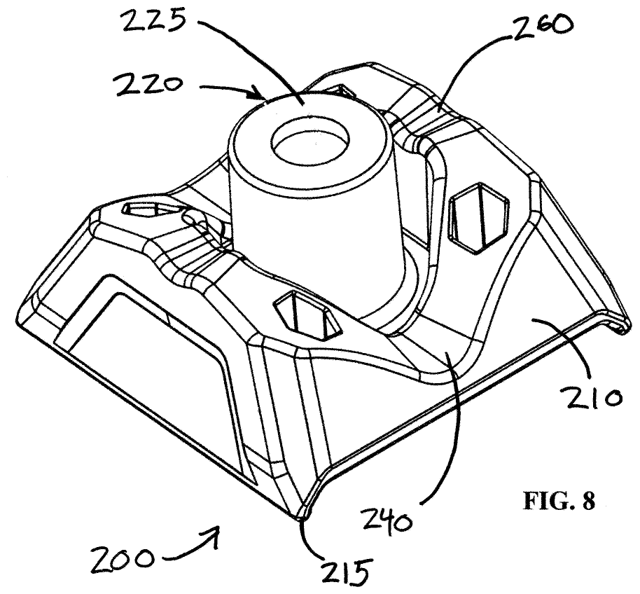

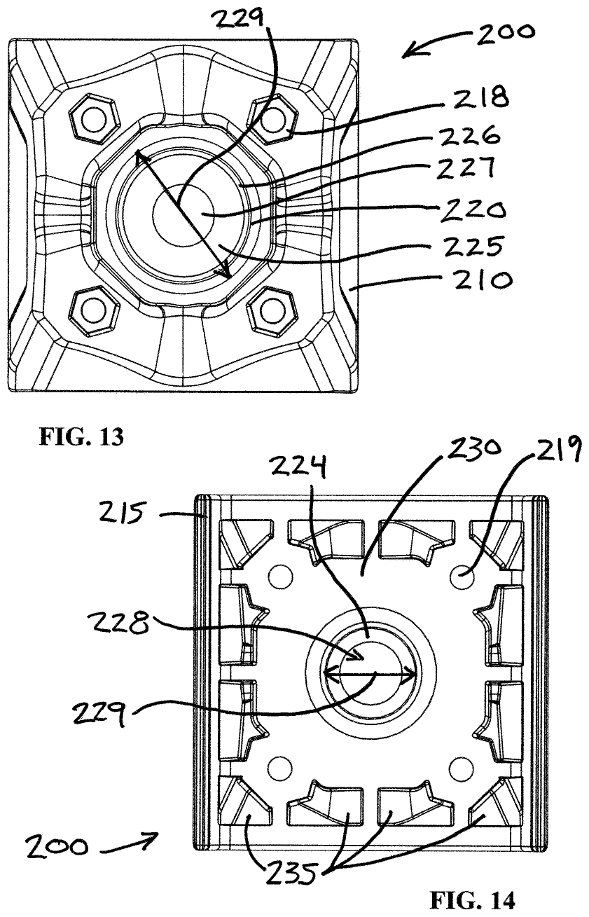

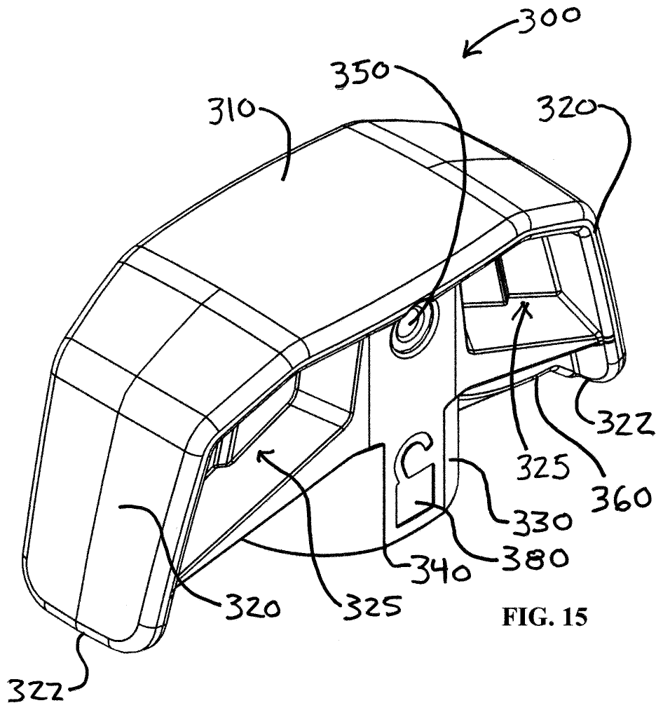

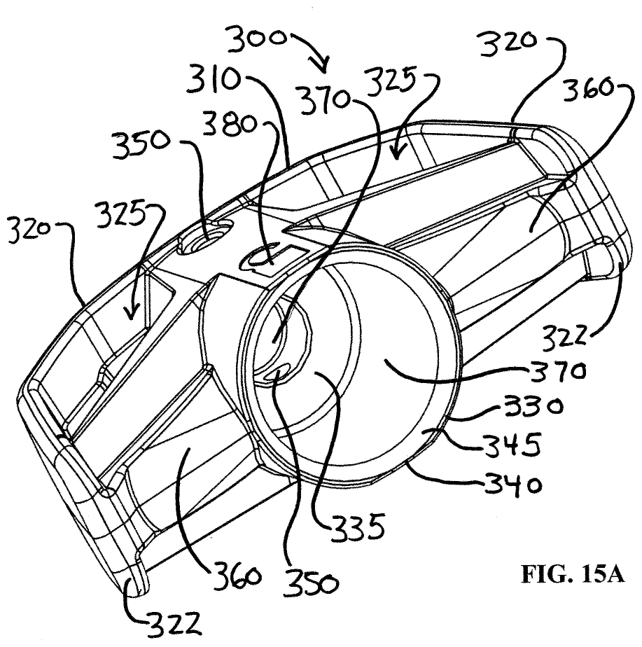

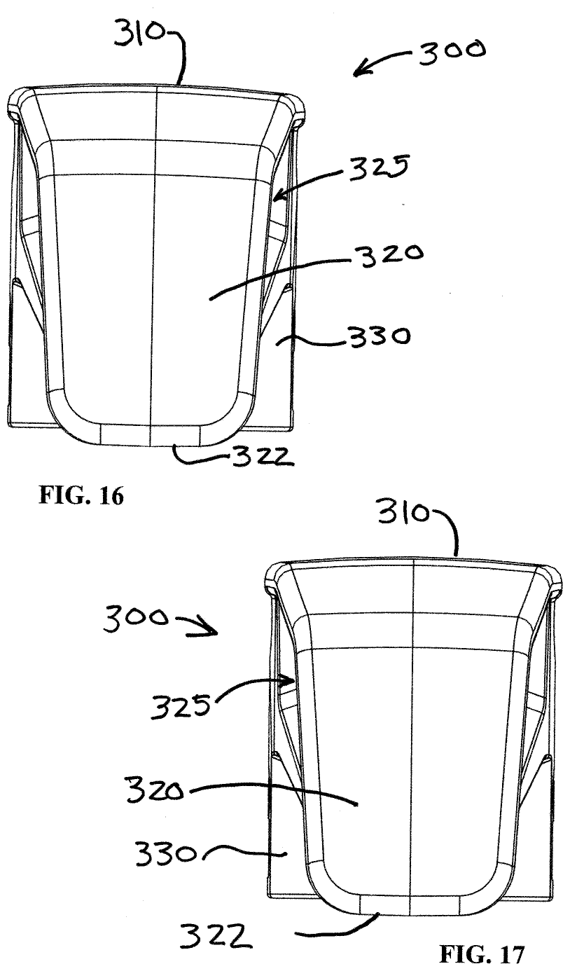

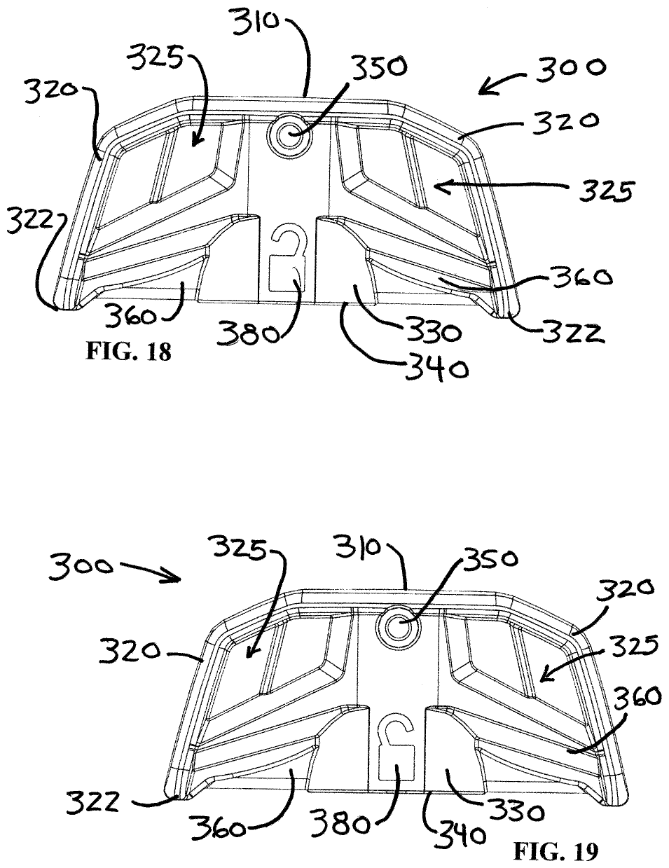

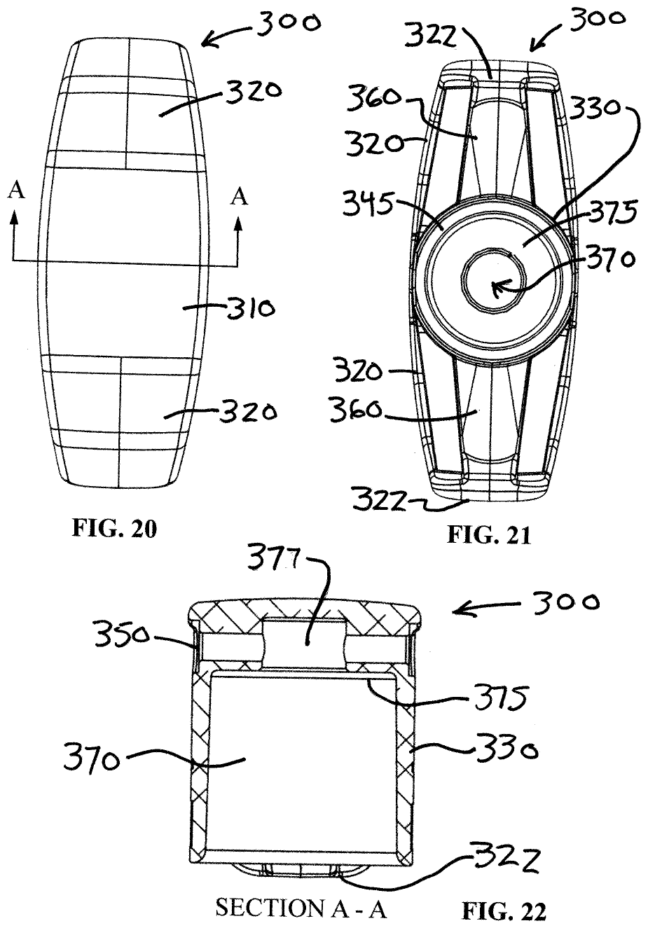

The present invention is a ladder rail lock, as most clearly illustrated at 100 in FIGS. 1-6 and 26-31. The ladder rail lock 100 is mounted on the outer rail 610 of a ladder 600 that is slidably mounted to an inner rail 630. The ladder rail lock 100 comprises four main components: a base 200, a handle 300, a plug 400, and a biasing mechanism, preferably a spring 430. The base ladder rail lock 100 is preferably mounted by its base 200 to a ladder outer rail 610 via rivets (not shown). In the preferred embodiment, the rivets attach through a bolt head slot 218 and bold shaft orifice 219 in the base 200 (see FIG. 13-14). This arrangement allows for replacement of the ladder rail lock 100 with nuts and bolts if the lock 100 were to become damaged or worn.

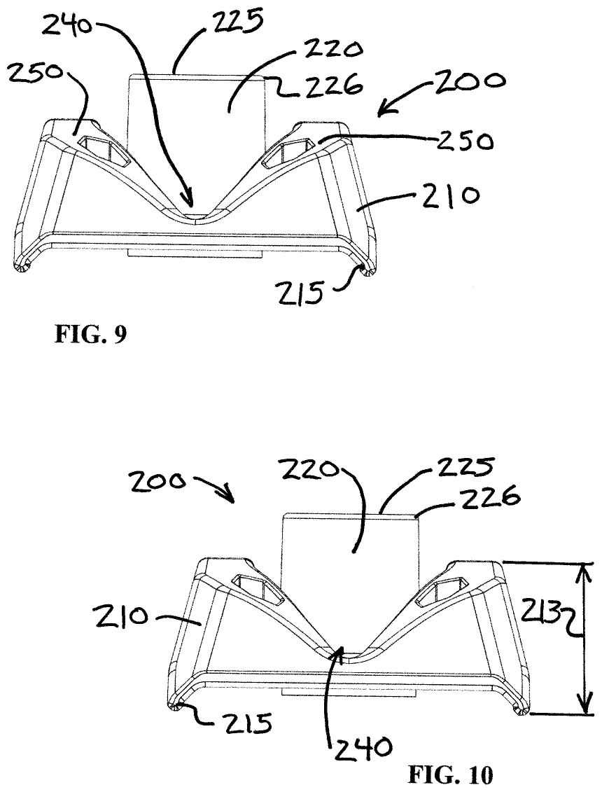

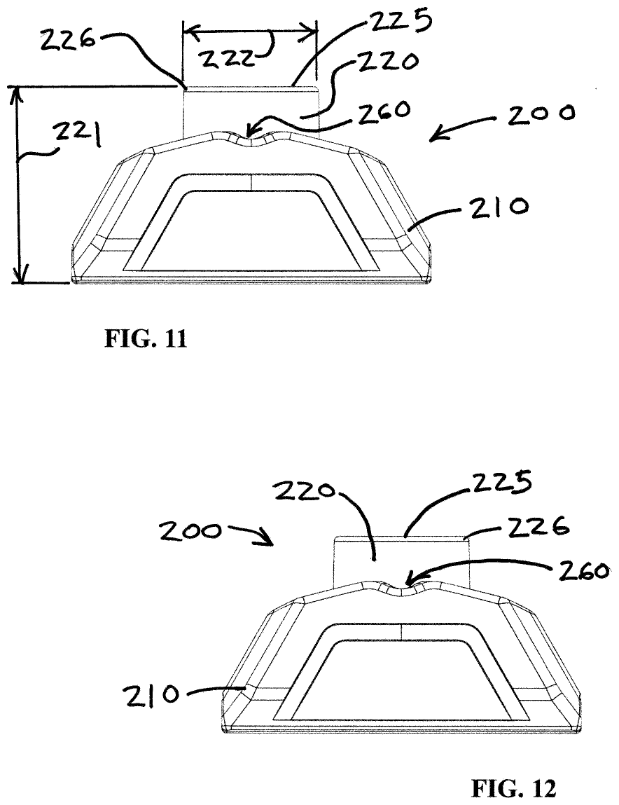

The base 200 is shown in more detail in FIGS. 8-14 and comprises a main body 210 having a main body height 213 with a cylinder 220 having a cylinder height 221. The base 200 has a bottom surface 230 that preferably abuts and is coplanar with the outer rail outer surface 615. It is desirable for the ladder rail lock 100 to be mounted at the place along the outer rail 610 as a ladder rung 620 and most desirable to be mounted at the same place along the ladder rail 610 as the top rung.

The base 200 is preferably square in footprint, having a length 211 and width 212 that are substantially equal. This arrangement provides necessary strength and stiffness for the ladder rail lock 100 while minimizing the risk of the lock 100 or ladder 600 catching on something while being moved or from individuals from catching clothing or tools on the lock 100 or ladder 600 when moving near the ladder 600.

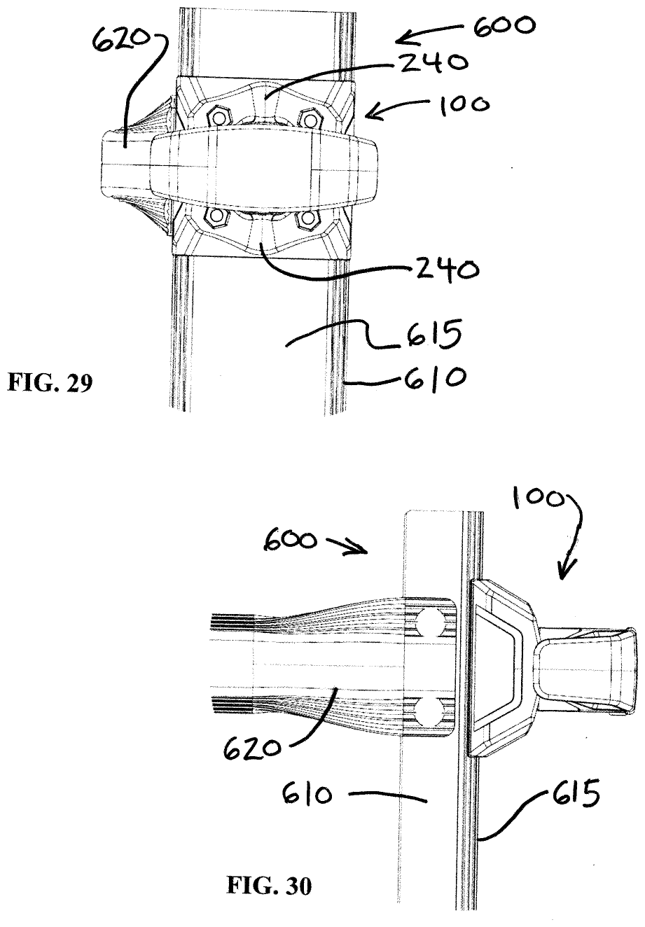

The base 200 includes a cylinder 220 that is preferably mounted in the center of the base 200 footprint to accommodate and allow the plug head 410 to slide axially with minimal friction on its interior (i.e., the plug head diameter 415 is slightly less than the cylinder plug channel diameter 229) and fits within the handle cylinder cavity 370 to allow the handle 300 to move along the cylinder 220 with minimal friction (i.e., the handle cylinder cavity 370 is slightly larger than the base cylinder outer diameter 222). The plug shaft 420 slides axially through the base cylinder plug orifice 227 at the base cylinder top 225. To facilitate axial alignment of the handle 300 in relation to the base 200, the base has a bevel 226 along its top 225 and the handle channel bottom 340 has a bevel 345. The handle channel bottom 340 is dimensioned so that it does not contact the base 300 to limit contact between the handle base contact surface 360 and the base handle crevice 240. The cylinder 200 has a height 221 sufficient that when the handle 300 is in the unlocked position (FIGS. 29-31), the plug head 410 is withdrawn so that it is within the base 200 (i.e., the plug head 410 is above the base bottom surface 230 and, thus removed completely from rails 610, 630). To facilitate the plug head 410 entering openings on the rails 610, 630, the plug head 410 preferably has a tapered end 440. While the meeting of the handle base contact surface 360 with the base handle crevice 240 limits the furthest the plug 400 can extend from the base bottom surface 230, a hand cylinder cavity end 375 can also be used to limit the extension of the plug 400.

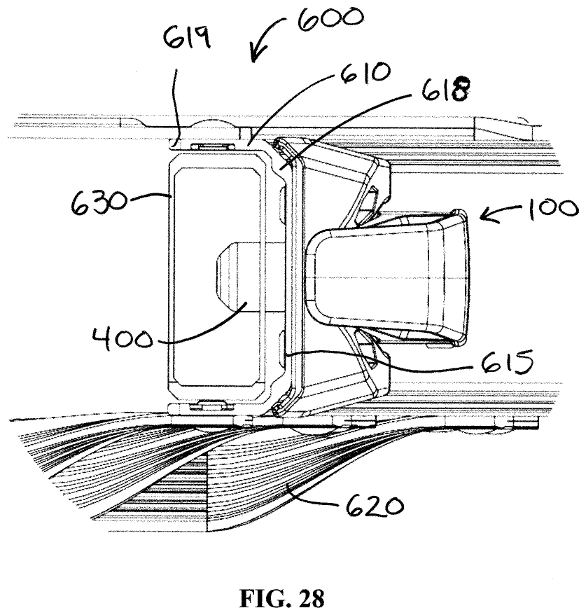

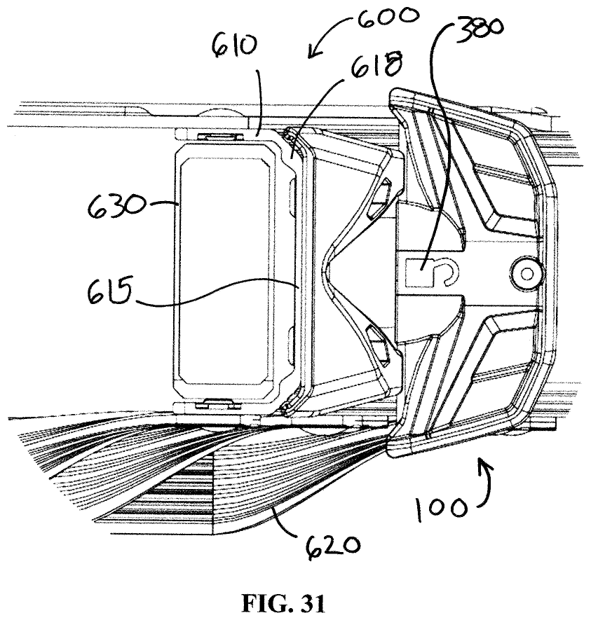

Because ladder rails are usually manufactured with a bevel on the outer rails 610 to remove sharp corners and improve strength of the rails (e.g., see U.S. Pat. No. D855,833 to Foley, et al.), the base 300 of the present invention preferably includes lips 215 formed to fit the bevel of the rail (see FIGS. 28 and 31). This arrangement provides additional protection against forces that may contact the sides of the base 200 exposed at the front or rear of the ladder 600. While the ladder rail lock 100 is mounted to the outer surface 615 of the outer rail 610, the base lips 215 wrap around the corner 618 of the outer rail and may or may not extend to or beyond the front or rear face 619 of the outer rail 610.

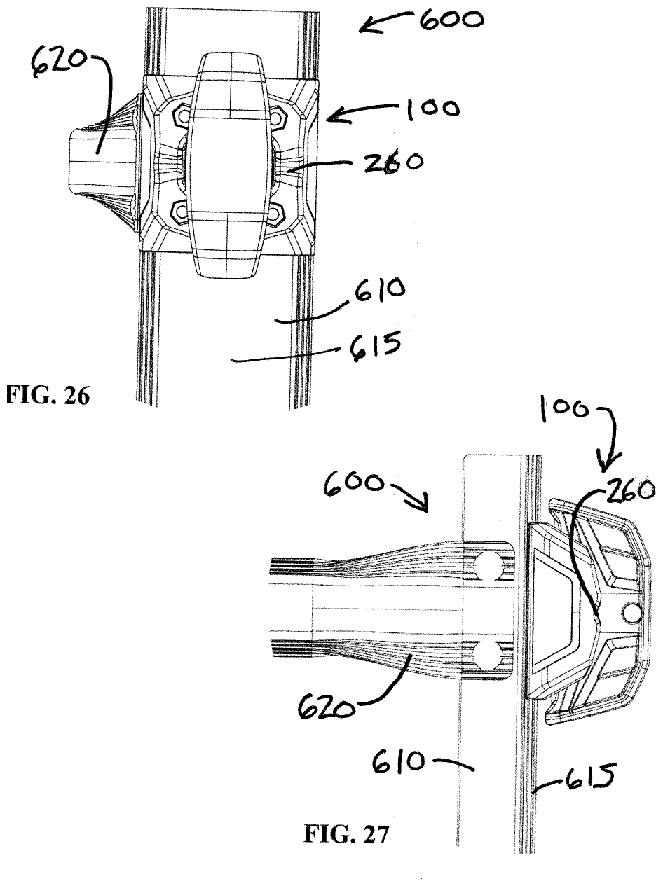

The base 200 also includes a handle crevice 240 with ramparts 250 on either side of the crevice 240 and a pair of handle notches 260 at the highest point of the ramparts 250. The handle crevice 240 is formed to accommodate and closely fit the contours of handle base contact surface 360 so that the ladder rail lock 100 maintains the locked position (FIGS. 26-29) without activation by a user. When the handle 300 is in the unlocked position, the handle base contact surface 360 rests on the handle notches 260, which are also formed to accommodate and closely fit the contours of the handle base contact surface 360 to maintain the position of the handle 300. This configuration allows the handle base contact surface 360 to slide along the base ramparts 250 when the handle 300 is twisted from locked to unlocked positions. This arrangement further causes the ladder rail lock 100 to automatically move into the locked position (i.e., into the base handle crevice 240) when the handle base contact surface 360 is not completely within the base handle notches 260 due to the biasing of the rail lock spring 430 causing the handle contact surface 360 to slide down the base ramparts 250.

The handle 300 comprises two wings 320 that extend beyond the footprint of the base 200 in both the locked and unlocked positions. The handle 300 includes finger inserts 325 to facilitate grip of the handle 300 when a user is locking or unlocking the ladder rail lock 100. The finger inserts 327 may include grips 327 that can be knurls in the interior surface of the insert 327 or may be added material like rubber for comfort, better handling, and improved tactile response. As best seen in FIG. 22, the handle wings 320 may include handle wing ends 322 that extend beyond the base 300 to prevent exposure of either the handle crevice 240 or handle notches 260 when the handle base contact surface 360 is in contact for the locked or unlocked position, respectively. The handle top 310 is preferably a flat or near-flat surface to lower the profile of the ladder rail lock 100 and for comfort.

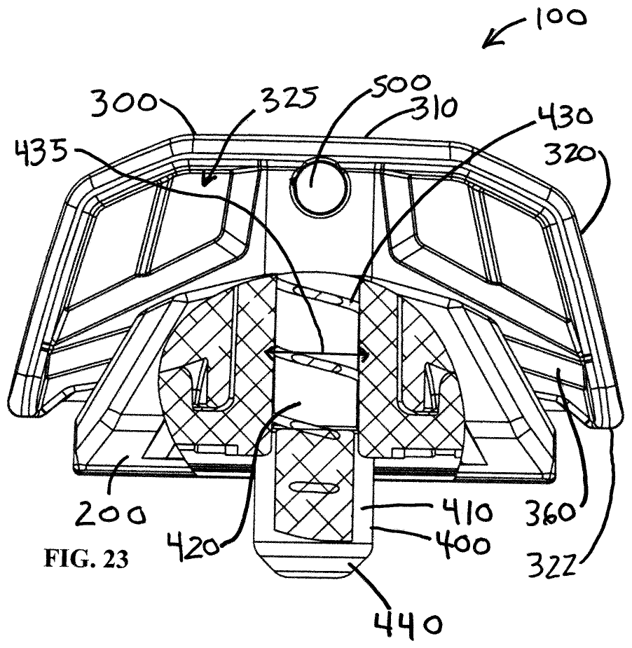

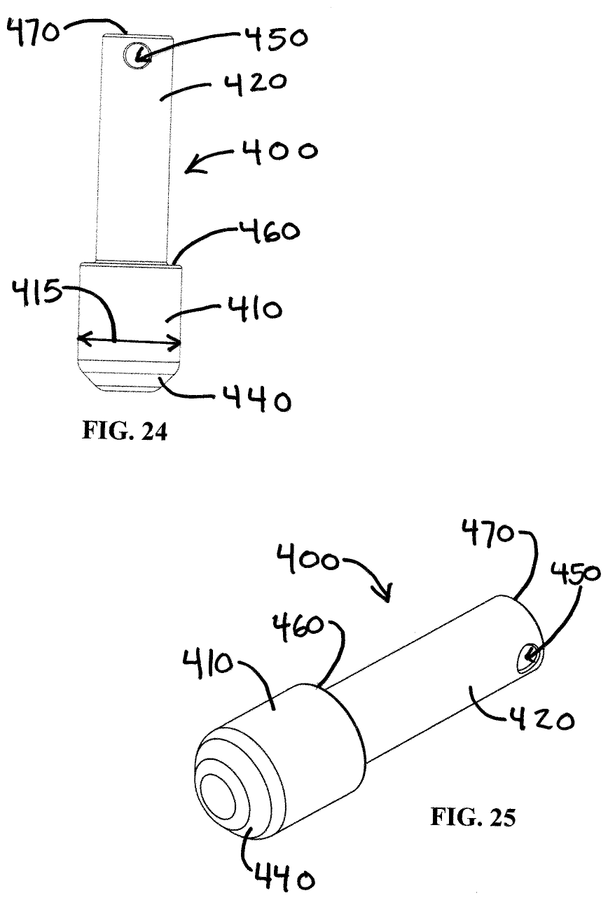

The ladder rail lock 100 is biased in the locked position via a biasing member, preferably a spring 430 (see FIG. 23) that is axial to the plug shaft 420 and rests between the plug shoulder 460 and the base plug stop 224. The diameter 435 of the spring 430 is such that it can ride inside the base cylinder plug channel 228 without interfering with movement of the plug 400 from the locked to unlocked position. Preferably, the diameter 435 of the spring 430 is slightly less than the plug head diameter 415 to limit friction while being compressed when unlocking the ladder rail lock 100. The base plug stop 224 acts to limit the maximum the plug 400 can be moved into the unlock position by providing a limit to the plug shoulder 460. The plug 400 is preferably attached to the handle 300 via a rivet 500 that transverses a handle rivet aperture 350 near the handle top 310 and plug rivet aperture 450 at the plug handle end 470 with the plug handle end 470 within a handle plug handle end cavity 377. However, the plug may be attached to the handle 300 using any means known in the art.

Another embodiment of the present invention includes an unlocked indicator 380 on the handle 300 that is not visible when the ladder rail lock 100 is in the locked position (see FIGS. 28-31). However, when the ladder rail lock 100 is moved out of the locked position, the indicator 380 becomes visible on the handle 300. The preferable location of the indicator 380 is at the lower portion of the handle cylinder channel 330 on the sides away from the handle wings 320. This allows the indicator 380 to be visible to warn a user that the ladder rails 610, 630 are not locked (see FIG. 31). The indicator can be any symbol and may be painted on, a sticker, etched into the handle 300, or even a light, the preferred method is to have the indicator 380 molded into the handle cylinder channel 330 to provide a permanent indicator that will not accidentally be removed or not function as a warning. The indicator 380 is also preferably colored so that it stands out against the other colors of the handle 300.

The base 200 is preferably made of a combination of methacrylatebutadiene-styrene, polycarbonate, and acrylonitrile butadiene styrene that is UV treated to allow detailed molding of the base 200 with sufficient strength and providing a lightweight material. To lower the weight of the ladder rail lock 200, the base bottom surface 230 may have cavities 235 to minimize the weight of the base 200. It is preferable that the handle 300 and plug 400 be constructed of lightweight aluminum to provide greater strength and wearability to those parts. However, any of the parts may be constructed of materials known in the art that will provide the same functionality, strength, and durability.

It is contemplated that features disclosed in this application, as well as those described in the above applications incorporated by reference, can be mixed and matched to suit particular circumstances. Various other modifications and changes will be apparent to those of ordinary skill.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations, and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

We claim:

1. A ladder rail lock comprising:
a base comprising:
a main body having a length and a width forming a footprint, and a height;
a cylinder having a height and diameter;
a cylinder plug orifice having a channel with a channel diameter;
a plug stop;
a handle crevice;
a handle notch; and
a rampart between the handle crevice and the handle notch;
a handle having a locked and an unlocked position comprising;
a wing with a wing end;
a cylinder channel; and
a base contact surface;
a plug comprising;
a shaft;
a head; and
a shoulder; and
a biasing member coaxial with the plug shaft.

2. The ladder rail lock of claim 1 wherein the handle base contact surface is abutting the base handle crevice when the rail lock is in the locked position.

3. The ladder rail lock of claim 2 wherein the handle base contact surface is abutting the base handle notch when the rail lock is in the unlocked position.

4. The ladder rail lock of claim 3 wherein the handle can rotate coaxially with the base cylinder and wherein when the handle rotates coaxially with the base cylinder the handle base contact surface contacts the rampart.

5. The ladder rail lock of claim 4 wherein the main body length and width are substantially equal.

6. The ladder rail lock of claim 4 wherein the base cylinder is at least partially within the handle cylinder channel.

7. The ladder rail lock of claim 4 wherein the wing end extends beyond the footprint of the base main body in both the locked and unlocked positions.

8. The ladder rail lock of claim 4 wherein the base main body comprises a lip on the sides of the base main body with handle notches.

9. The ladder rail lock of claim 4 wherein the base main body comprises a bolt head slot and bolt shaft orifice.

10. The ladder rail lock of claim 9 wherein the bolt head slot is hexagonal.

11. The ladder rail lock of claim 1 wherein the biasing member is a spring and the spring rests between the plug shoulder and the base plug stop.

12. The ladder rail lock of claim 1 wherein the handle base contact surface is non-planar.

13. An extension ladder comprising:
an outer rail having an outer surface and corner;
an inner rail slidable in relation to the outer rail;
a ladder rail lock mounted to the outer surface comprising:
a base comprising:
a main body comprising a footprint;
a cylinder;
a cylinder plug orifice having a channel;
a plug stop;
a handle crevice;
a handle notch;
a rampart between the handle crevice and the handle notch; and
a lip that wraps at least partially around the corner of the outer rail;
a handle having a locked and an unlocked position comprising;
a wing;
a cylinder channel; and
a base contact surface;
a plug comprising;
a shaft;
a head; and
a shoulder; and
a biasing member.

14. The extension ladder of claim 13 wherein the handle base contact surface is abutting the base handle crevice when the rail lock is in the locked position.

15. The extension ladder of claim 14 wherein the handle base contact surface is abutting the base handle notch when the rail lock is in the unlocked position.

16. The extension ladder of claim 15 wherein the biasing member is a spring, and the spring is coaxial to the plug shaft and rests between the plug shoulder and the base plug stop.

17. The extension ladder of claim 16 wherein the wing comprises a wing end and the wing end extends beyond the footprint of the base main body in both the locked and unlocked positions.

18. The l extension ladder of claim 17 wherein the handle base contact surface is non-planar.

19. The extension ladder of claim 18 wherein the main body comprises a length and a width and the length and width are substantially equal.

20. A ladder rail lock comprising:
a base comprising:
a main body comprising a footprint;
a cylinder;
a cylinder plug orifice having a channel;
a plug stop;
a handle crevice;
a handle notch;
a rampart between the handle crevice and the handle notch; and
a lip;
a handle having a locked and an unlocked position comprising;
a wing comprising a wing end wherein the wing end extends beyond the main body footprint in both the locked and unlocked positions;
a cylinder channel; and
a non-linear base contact surface;
a plug comprising;
a shaft;
a head; and
a shoulder; and
a spring coaxial to the plug shaft located between the plug shaft shoulder and the base plug stop.
